(19) United States
(12) Patent Application Publication
(10) Pub. No.: US 2020/0381885 A1
(43) Pub. Date: Dec. 3, 2020

(54) OPTICAL AMPLIFIER

(71) Applicant: SUMITOMO ELECTRIC INDUSTRIES, LTD., Osaka (JP)

(72) Inventor: Takafumi OHTSUKA, Osaka-shi (JP)

(73) Assignee: SUMITOMO ELECTRIC INDUSTRIES, LTD., Osaka (JP)

(21) Appl. No.: 16/881,806

(22) Filed: May 22, 2020

(30) Foreign Application Priority Data
May 30, 2019 (JP) 2019-101015

(51) Int. Cl. H01S 3/094; H01S 3/067; H01S 3/06; H01S 3/16

(52) U.S. Cl. CPC H01S 3/094015; H01S 3/06754; H01S 3/1608; H01S 3/06733; H01S 3/0625; H01S 3/06737

(57) ABSTRACT

An optical amplifier according to an embodiment includes a pump laser that emits a pumping light beam, and an external resonator that is provided on the outside of the pump laser. In the inside of the external resonator, an optical waveguide that is doped with a rare earth element which absorbs the pumping light beam and that amplifies a signal light beam is disposed, and residual pumping light beams and which are emitted from the optical waveguide are confined.

### TECHNICAL FIELD

An aspect of the present disclosure relates to an optical amplifier.

### BACKGROUND

S. Takasaka, “Cladding Pump Recycling in 7-core EDFA” ECOC2018 We.1E, Maeda, et al., “Collection of Residual Pumping Light Beam of Cladding Simultaneous Pumping Type EDF” Institute of Electronics, Information and Communication Engineers Conference B-10-18, 2018, and H. Takeshita, “Transmission of 200 Gbit per sec PM-16QAM Signal through 7-core MCF and MC-EDFA using Novel Turbo Cladding Pumping Scheme of Improved Efficiency of the Optical Amplification,” ECOC2018 We.2 describe multicore optical fiber amplifiers according to cladding pumping schemes. The multicore optical fiber amplifier includes a residual pumping light beam collector that collects a residual pumping light beam and a residual pumping light beam recombiner that recombines the residual pumping light beam collected by the residual pumping light beam collector. In the residual pumping light beam recombiner, a side-to-side coupling scheme is adapted in which a single-core multimode fiber is fused and connected to the lateral side of a multicore fiber.

### SUMMARY

An optical amplifier according to an aspect of the present disclosure includes a pump laser configured to emit a pumping light beam and an external resonator provided on an outside of the pump laser. In an inside of the external resonator, an optical waveguide is disposed, the optical waveguide being doped with a rare earth element which absorbs the pumping light beam, the optical waveguide being configured to amplify a signal light beam, and a residual pumping light beam emitted from the optical waveguide is confined in the inside of the external resonator.

### BRIEF DESCRIPTION OF THE DRAWINGS

FIG. 1 is a diagram showing the configuration of an optical amplifier according to a first embodiment;

FIG. 2 is a diagram showing the configuration of an optical amplifier according to a second embodiment;

FIG. 3 is a graph showing the relationship between the pumping light electric power and the power efficiency of optical amplifiers according to examples; and

FIG. 4 is a diagram showing the configuration of a previously existing optical amplifier.

### DETAILED DESCRIPTION

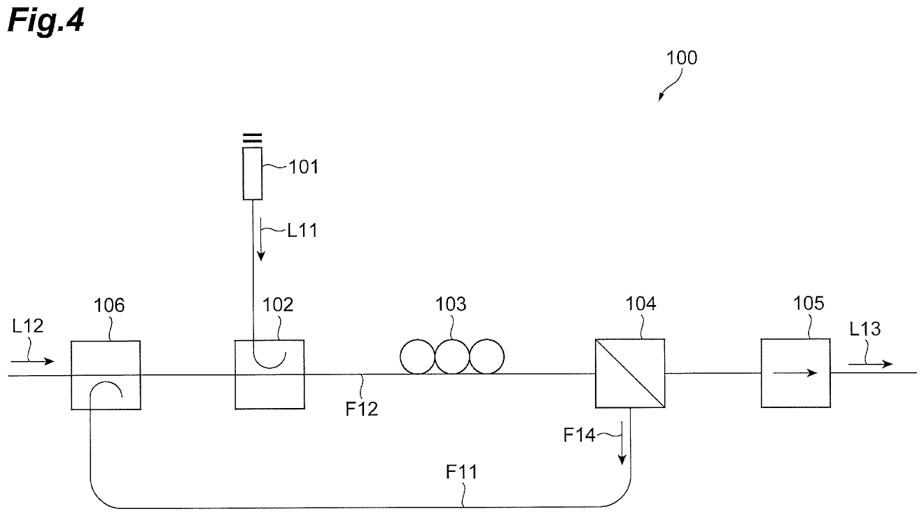

FIG. 4 shows an exemplary optical amplifier 100 is a multicore optical fiber amplifier according to a side-to-side coupling scheme. The optical amplifier 100 includes a pump laser 101, a pump combiner 102, an erbium-doped optical fiber (EDF) 103, a residual pumping light beam collector 104, an optical isolator 105, and a residual pumping light beam recombiner 106. The residual pumping light beam collector 104 and the residual pumping light beam recombiner 106 are optically coupled to each other through a multimode fiber F11. The residual pumping light beam recombiner 106, the pump combiner 102, the EDF 103, the residual pumping light beam collector 104, and the optical isolator 105 are optically coupled to each other through a multicore fiber F12.

The pump laser 101 emits a pumping light beam L11. The pumping light beam L11 is entered to the EDF 103 together with a signal light beam L12, and the erbium in the EDF 103 absorbs the pumping light beam L11, and thus the signal light beam L12 is amplified. A signal light beam L13 amplified at the EDF 103 is emitted to the outside of the optical amplifier 100 through the optical isolator 105. A residual pumping light beam L14 which is the remaining part of the pumping light beam L11 and which passes through the EDF 103 is collected at the residual pumping light beam collector 104. The residual pumping light beam L14 which is collected at the residual pumping light beam collector 104 is recombined with the residual pumping light beam recombiner 106 through the multimode fiber F11.

In the optical amplifier 100, it is necessary to include the multimode fiber F11 and the multicore fiber F12 as a plurality of optical fibers that collects and recombines the residual pumping light beam L14. In the residual pumping light beam recombiner 106, the multimode fiber F11 is coupled to the lateral side of the multicore fiber F12. Therefore, the residual pumping light beam L14 is entered to the residual pumping light beam recombiner 106 through the multimode fiber F11, and is recombined with the multicore fiber F12. In this optical amplifier 100, a problem possibly arises that the pumping light beam L11 or the residual pumping light beam L14 leaks from the residual pumping light beam collector 104 to the optical isolator 105, and leaks to the outside of the optical amplifier 100. Since the residual pumping light beam L14 is entered to the EDF 103 similarly to the pumping light beam L11, it is difficult to improve the use efficiency of the pumping light beam in the EDF 103. That is, in the optical amplifier according to the side-to-side coupling scheme like the optical amplifier 100, there is a room to improve the use efficiency of the pumping light beam.

An object of an aspect of the present disclosure is to provide an optical amplifier that can improve the use efficiency of a pumping light beam.

According to the present disclosure, the use efficiency of the pumping light beam can be improved.

### Description of Embodiments

First, the content of embodiments will be described in enumeration. An optical amplifier according to an embodiment includes a pump laser configured to emit a pumping light beam and an external resonator provided on an outside of the pump laser. In the inside of the external resonator, an optical waveguide is disposed, the optical waveguide being doped with a rare earth element which absorbs the pumping light beam, the optical waveguide being configured to amplify a signal light beam, and a residual pumping light beam emitted from the optical waveguide is confined in the inside of the external resonator.

In this optical amplifier, the external resonator is provided on the outside of the pump laser, and in the inside of the external resonator, the optical waveguide that is doped with a rare earth element and that amplifies a signal light beam is disposed. The residual pumping light beam which passes through the optical waveguide that is doped with the rare earth element is confined in the inside of the external resonator. Therefore, the residual pumping light beam which is confined in the inside of the external resonator can be again passed through the optical waveguide, and thus the absorption efficiency of the pumping light beam which is absorbed in the rare earth element can be improved. That is, the confine of the residual pumping light beam in the inside of the external resonator can improve a probability that the rare earth element absorbs the pumping light beam. As a result, the power efficiency of the pump laser can be improved.

### Detail of Embodiments of the Present Disclosure

Specific examples of optical amplifiers according to embodiments of the present disclosure will be described with reference to the drawings. The present invention is not limited to specific examples below, and is intended to include all modifications and alterations described in claims and in the scope equivalent to the scope of claims. In the description of the drawings, the same or corresponding components are designated with the same reference signs, and the duplicate description is appropriately omitted. For easy understanding, the drawings are sometimes partially simplified or exaggerated, and dimensions, ratios, and any other parameters are not limited to ones described in the drawings.

### First Embodiment

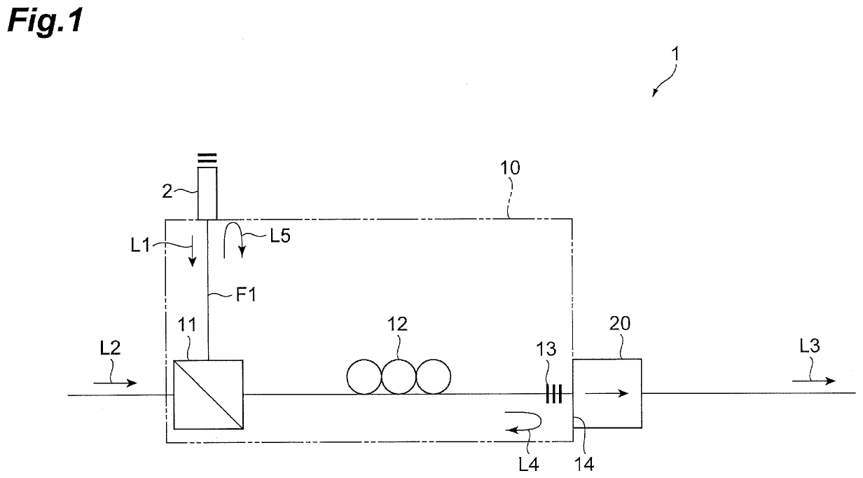

FIG. 1 is a diagram showing the configuration of an optical amplifier 1 according to a first embodiment. The optical amplifier 1 configures an optical fiber amplifier that is used in an optical communication system which transmits signal light beams in a multicore fiber (MCF), for example. The optical amplifier 1 according to the present embodiment uses a simultaneous cladding pumping scheme in which signal light beams in a plurality of cores of a multicore fiber are simultaneously pumped. In the optical amplifier 1, as an example, signal light beams in the C band are amplified.

The optical amplifier 1 includes a pump laser 2 that emits a pumping light beam L1, an external resonator 10 that is provided on the outside of the pump laser 2 and that amplifies a signal light beam L2 which is entered to the optical amplifier 1, and an optical isolator 20 that transmits a signal light beam L3 which is amplified to the outside of the optical amplifier 1. The pump laser 2 is connected to the external resonator 10 (a pump combiner 11, described later) through a multimode fiber F1, for example. As an example, the pump laser 2 is a semiconductor laser diode that emits the pumping light beam L1. The pump laser 2 may be a semiconductor laser light source that supplies the pumping light beam L1 at a wavelength of 0.98 μm or a wavelength of 1.48 μm to the external resonator 10, for example.

The external resonator 10 includes the pump combiner 11 at which the pumping light beam L1 is coupled to the signal light beam L2, an optical waveguide 12 that is doped with a rare earth element which absorbs the pumping light beam L1, the optical waveguide 12 amplifying the signal light beam L2, a reflecting mirror 13 that reflects a residual pumping light beam L4 which is emitted from the optical waveguide 12, and a light emitting end face 14 from which a signal light beam L3 which is emitted from the optical waveguide 12 is emitted to the outside of the external resonator 10. The pump combiner 11 is a wavelength division multiplexing coupler (WDM coupler), for example.

The optical waveguide 12 is a gain fiber having a double-cladding structure, for example. The optical waveguide 12 is a rare-earth-doped optical fiber that is doped with a rare earth element, and is a multicore fiber having a double-cladding structure that guides the pumping light beam L1. Here, the term “multicore fiber having a double-cladding structure” expresses a multicore fiber further including a plurality of cores, a plurality of claddings that individually covers the plurality of cores, and a cladding that covers the plurality of claddings. The optical waveguide 12 has seven cores or 19 cores, for example. The optical waveguide 12 simultaneously pumps the signal light beam L2 passing through each of the plurality of cores, and simultaneously amplifies the signal light beams L2.

The optical waveguide 12 is in a spiral shape, for example. The optical waveguide 12 may configure an erbium-doped multicore optical fiber amplifier (coupling amplifier) that is doped with erbium (Er). In this case, the optical waveguide 12 has a plurality of cores that is doped with Er and a cladding that surrounds the plurality of cores. To the optical waveguide 12, the pumping light beam L1 and the signal light beam L2 are supplied. When the pumping light beam L1 is supplied to the optical waveguide 12, the Er element, for example, which is doped in the cores of the optical waveguide 12 is pumped as well as the signal light beam L2 is amplified.

The reflecting mirror 13 is disposed at a position adjacent to the optical waveguide 12 (on the downstream side of the optical waveguide 12), for example. The reflecting mirror 13 is a residual pumping light beam reflective filter that reflects the residual pumping light beam L4, which is not absorbed in the optical waveguide 12, to the optical waveguide 12. Since this reflecting mirror 13 returns the residual pumping light beam L4 directly to the optical waveguide 12, the optical density of the pumping light beams (the pumping light beam L1 and the residual pumping light beam L4) in the optical waveguide 12 can be improved as well as the use efficiency of the pumping light beam emitted from the pump laser 2 can be improved.

A residual pumping light beam L5 which is not absorbed in the optical waveguide 12 and is emitted from the optical waveguide 12 toward the pump combiner 11 is returned to the pump laser 2, and is reflected to the pump combiner 11 at the pump laser 2. As described above, the residual pumping light beams L4 and L5 reciprocate between the reflecting mirror 13 and the pump laser 2, and thus the pumping light beams can be confined in the inside of the external resonator 10. The optical amplifier 1 adopts a bidirectional pumping scheme in which a pumping light beam is entered to the optical waveguide 12 from two directions and the signal light beam L2 is pumped, and thus low noise and high power emission can be both combined.

From the light emitting end face 14, the signal light beam L3 which is amplified at the optical waveguide 12 is emitted. The signal light beam L3 from the light emitting end face 14 is entered to the optical isolator 20, and emitted to the outside of the optical amplifier 1 through the optical isolator 20. The optical isolator 20 includes an isolator block made of magneto-optical crystal. For example, at the incident end of the optical isolator 20, a wavelength selective mirror is disposed.

In the present embodiment, for example, the reflecting mirror 13, the light emitting end face 14, and the optical isolator 20 are integrated with each other. Here, the term “integrated” includes the meaning that a plurality of components is fixed to each other are well as includes the meaning that a plurality of components is collectively disposed at a predetermined place. The light emitting end face 14 may be the incident end face of the optical isolator 20, for example, or the reflecting mirror 13 may be disposed on the light emitting end face 14 that is the incident end face of the optical isolator 20.

Next, the operation and effect of the optical amplifier 1 according to the present embodiment will be described. In the optical amplifier 1, the external resonator 10 is provided on the outside of the pump laser 2, and in the inside of the external resonator 10, the optical waveguide 12 that is doped with a rare earth element and that amplifies the signal light beam L2 is disposed. The residual pumping light beams L4 and L5 which pass through the optical waveguide 12 that is doped with a rare earth element is confined in the inside of the external resonator 10. Therefore, the residual pumping light beams L4 and L5 which are confined in the inside of the external resonator 10 can be passed through the optical waveguide 12, and thus the use efficiency of the pumping light beam which is absorbed in the rare earth element can be improved.

That is, the confines of the residual pumping light beams L4 and L5 in the inside of the external resonator 10 can improve a probability that the rare earth element absorbs the pumping light beam. As a result, the power efficiency of the pump laser 2 can be improved. In the optical amplifier 1 according to the present embodiment, the pump laser 2 is a semiconductor laser diode. Therefore, the size of the pump laser 2 can be reduced.

In the optical amplifier 1 according to the present embodiment, the optical waveguide 12 that is doped with a rare earth element is a rare-earth-doped optical fiber. As described above, as the optical waveguide 12 that is disposed in the inside of the external resonator 10, the rare-earth-doped optical fiber can be used.

In the optical amplifier 1 according to the present embodiment, the rare-earth-doped optical fiber is a multicore fiber having a plurality of cores. Consequently, since the rare-earth-doped optical fiber is a multicore fiber and the number of cores of the optical waveguide 12 is a multiple number, the absorption efficiency of the pumping light beam can be further improved.

In the optical amplifier 1 according to the present embodiment, the rare-earth-doped optical fiber may have a double-cladding structure that guides a pumping light beam. In this case, the rare-earth-doped optical fiber has the double-cladding structure, and thus the optical amplifier 1 having a cladding pumping scheme can be formed.

In the optical amplifier 1 according to the present embodiment, the external resonator 10 has a reflecting mirror 13 that reflects the residual pumping light beam L4 which is emitted from the optical waveguide 12 to the optical waveguide 12 and the light emitting end face 14 from which the signal light beam L3 amplified at the optical waveguide 12 is emitted to the outside of the external resonator 10. Therefore, the external resonator 10 includes the reflecting mirror 13 that reflects the residual pumping light beam L4 to the optical waveguide 12, and thus the residual pumping light beam L4 which is not fully absorbed at the optical waveguide 12 can be entered to the optical waveguide 12 by the reflecting mirror 13. Accordingly, the absorption efficiency of the pumping light beam in the optical waveguide 12 can be further improved.

A configuration can be provided in which the residual pumping light beam L4 is again entered to the optical waveguide 12 by the reflecting mirror 13, and thus the configuration can be made simple while an increase in the number of parts is suppressed. More specifically, as a configuration that again uses a pumping light beam, the previously existing optical amplifier 100 shown in FIG. 4 needs the residual pumping light beam collector 104 and the residual pumping light beam recombiner 106, whereas the optical amplifier 1 can include the reflecting mirror 13 alone.

The optical amplifier 1 according to the present embodiment further includes the optical isolator 20, and the optical isolator 20 and the reflecting mirror 13 are integrated with each other. That is, the optical isolator 20 that is provided on the downstream side of the optical path of the signal light beam L3 which passes through the reflecting mirror 13 is integrated with the reflecting mirror 13. Therefore, the configuration can be made much simpler while the number of components is reduced.

### Second Embodiment

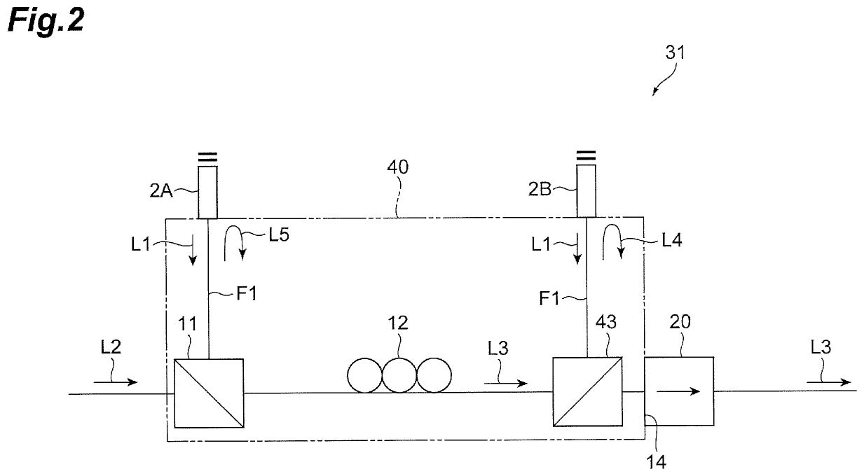

FIG. 2 is a diagram showing the configuration of an optical amplifier 31 according to a second embodiment. At least a part of the optical amplifier 31 includes a configuration similar to that of the optical amplifier 1, and the duplicate description of the optical amplifier 1 is appropriately omitted in the following description. The optical amplifier 31 includes a pump laser 2A and a pump laser 2B that emit a pumping light beam L1, an external resonator 40 that is provided on the outside of the pump laser 2A and the pump laser 2B, and an optical isolator 20. The pump laser 2A and the pump laser 2B are connected to the external resonator 40 through a multimode fiber F1, for example. The configurations of the pump laser 2A and the pump laser 2B are the same as the configuration of the pump laser 2 described above, for example.

The external resonator 40 includes a pump combiner 11 that couples the pumping light beam L1 to a signal light beam L2, an optical waveguide 12 that is doped with a rare earth element which absorbs the pumping light beam L1, a pump combiner 43 that couples the pumping light beam L1 to a signal light beam L3, and a light emitting end face 14 from which the signal light beam L3 is emitted to the outside of the external resonator 40. The pump combiner 43 is a wavelength division multiplexing coupler (WDM coupler) that is disposed at the position adjacent to the optical waveguide 12, for example.

The pump combiner 43 enters the pumping light beam L1 from the pump laser 2B to the optical waveguide 12. Since the pumping light beam L1 is directly entered to the optical waveguide 12 by the pump combiner 43, the optical densities of the pumping light beams in the optical waveguide 12 (the pumping light beam L1 from the pump laser 2A and the pumping light beam L1 from the pump laser 2B) can be improved as well as the use efficiency of the pumping light beams from the pump lasers 2A and 2B can be improved.

The pump combiner 43 reflects the residual pumping light beam L4 which is entered from the optical waveguide 12 to the pump laser 2B, and the residual pumping light beam L4 which reaches the pump laser 2B is reflected at the pump laser 2B, and is returned to the pump combiner 43. The residual pumping light beam L4 which is returned to the pump combiner 43 is again entered to the optical waveguide 12.

The residual pumping light beam L5 which is emitted from the optical waveguide 12 toward the pump combiner 11 is emitted from the pump combiner 11 to the pump laser 2A, reflected to the pump combiner 11 at the pump laser 2A, and returned to the pump combiner 11. The residual pumping light beam L5 which is returned to the pump combiner 11 is again entered to the optical waveguide 12. As described above, the residual pumping light beams L4 and L5 reciprocate between the pump laser 2A and the pump laser 2B, and thus the residual pumping light beams L4 and L5 can be confined in the inside of the external resonator 40.

As described above, in the optical amplifier 31 according to the second embodiment, the optical waveguide 12 that is doped with a rare earth element is disposed in the inside of the external resonator 40, and the residual pumping light beams L4 and L5 which pass through the optical waveguide 12 are confined in the inside of the external resonator 40. Therefore, similarly to the first embodiment, the use efficiency of the pumping light beam which is absorbed in the rare earth element can be improved.

The optical amplifier 31 according to the second embodiment includes a plurality of pump lasers (the pump laser 2A and the pump laser 2B), the pumping light beam L1 is entered to the optical waveguide 12 from the plurality of pump lasers, and the external resonator 40 has the light emitting end face 14 from which the signal light beam L3 amplified at the optical waveguide 12 is emitted to the outside of the external resonator 40. Consequently, the external resonator 40 is provided between the plurality of pump lasers, and the optical waveguide 12 is provided in the inside of the external resonator 40.

Therefore, the residual pumping light beams L4 and L5 can be confined in the inside of the external resonator 40 that is disposed between the plurality of pump lasers, and thus the absorption efficiency of the pumping light beam can be further improved. In the second embodiment, since two pump lasers are included, a drive electric current per pump laser can be suppressed by about a half, compared with the case in which one pump laser is included. As a result, the lifetime of the pump laser can be prolonged.

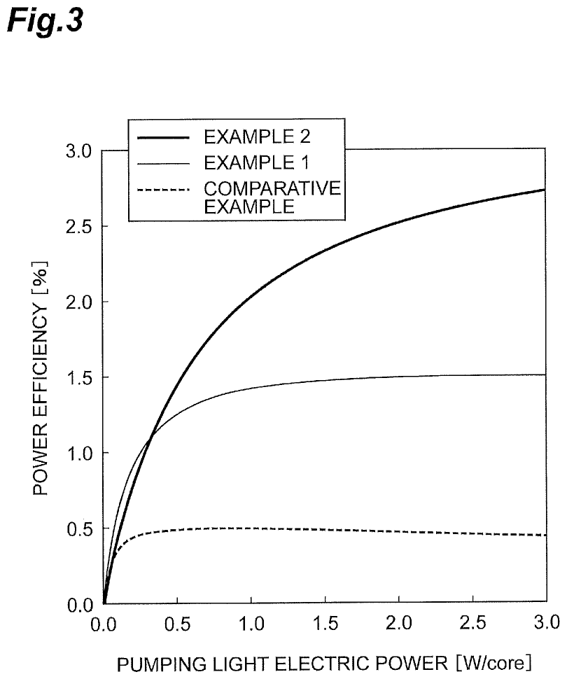

FIG. 3 is a graph showing the relationship between the pumping light electric power (electric power per core, unit: W/core) and the power efficiency (unit: %) of the optical amplifier according to the first example, the optical amplifier according to the second example, and an optical amplifier according to comparative example 1. The optical amplifier according to the first example is the optical amplifier 1 including the reflecting mirror 13, the optical amplifier according to the second example is the optical amplifier 31 including the plurality of pump lasers, and the optical amplifier according to comparative example 1 is the optical amplifier 100 including the residual pumping light beam collector 104 and the residual pumping light beam recombiner 106.

As shown in FIG. 3, it is revealed that in the optical amplifier according to the first example including the reflecting mirror 13 and the optical amplifier according to the second example including the plurality of pump lasers, power efficiency can be greatly improved, compared with the optical amplifier according to comparative example 1 including the residual pumping light beam collector 104 and the residual pumping light beam recombiner 106. Moreover, it is revealed that in the optical amplifier according to the second example including the plurality of pump lasers, power efficiency can be more improved than in the optical amplifier according to the first example including the reflecting mirror 13.

As described above, the embodiments and the examples of the optical amplifiers according to the present disclosure are described. However, the present invention is not limited to the content of the foregoing embodiment and examples, and can be variously modified within the scope not deviating from the scope in which the gist described in claims is not changed. That is, the types, numbers, functions, and disposition forms of the components that constitute the optical amplifier can be appropriately changed with the scope not deviating from the gist.

For example, in the foregoing embodiments, the optical waveguide 12 that is a gain fiber having a double-cladding structure is described. However, the optical waveguide may be a multicore fiber that does not have a double-cladding structure, and the type of optical waveguide that amplifies a signal light beam can be appropriately changed. In the foregoing embodiment, the optical amplifier 1 using a simultaneous cladding pumping scheme in which the signal light beams in the plurality of cores of the multicore fiber are simultaneously pumped is described. However, the present invention is also applicable to optical amplifiers using schemes other than the simultaneous cladding pumping scheme.

What is claimed is:

1. An optical amplifier comprising:
a pump laser configured to emit a pumping light beam; and
an external resonator provided on an outside of the pump laser, wherein
in an inside of the external resonator, an optical waveguide is disposed, the optical waveguide being doped with a rare earth element which absorbs the pumping light beam, the optical waveguide being configured to amplify a signal light beam, and
a residual pumping light beam emitted from the optical waveguide is confined in the inside of the external resonator.

2. The optical amplifier according to claim 1, wherein the optical waveguide that is doped with the rare earth element is a rare-earth-doped optical fiber.

3. The optical amplifier according to claim 2, wherein the rare-earth-doped optical fiber is a multicore fiber having a plurality of cores.

4. The optical amplifier according to claim 2, wherein the rare-earth-doped optical fiber includes a double-cladding structure that guides a pumping light beam.

5. The optical amplifier according to claim 1, wherein the external resonator includes
a reflecting mirror configured to reflect a residual pumping light beam emitted from the optical waveguide to the optical waveguide, and
a light emitting end face from which a signal light beam amplified at the optical waveguide is emitted to the outside of the external resonator.

6. The optical amplifier according to claim 5, further comprising an optical isolator, wherein
the optical isolator is integrated with the reflecting mirror.

7. The optical amplifier according to claim 1, further comprising a plurality of the pump lasers, wherein
to the optical waveguide, pumping light beams from the plurality of the pump lasers are individually entered, and
the external resonator includes a light emitting end face from which a signal light beam amplified at the optical waveguide is emitted to the outside of the external resonator.
